(19) United States
(12) Patent Application Publication
(10) Pub. No.: US 2003/0222867 A1
(43) Pub. Date: Dec. 4, 2003

(54) Energy consumption-rate indication for a battery-powered electronic device

(76) Inventors: Heather N. Bean, Fort Collins, CO (US); Mark N. Robins, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/162,331

(22) Filed: Jun. 4, 2002

(51) Int. Cl. G09G 5/00

(52) U.S. Cl. 345/211

(57) ABSTRACT

An energy consumption-rate meter determines an energy discharge rate of a battery installed in an electronic device. The meter further displays the battery discharge rate to a user of the device so that the user may use the device more energy-efficiently. An electronic device having the energy consumption-rate meter comprises a computer program that, when executed by a processor in the device, the program implements a method of gauging an energy consumption rate of the electronic device. The method comprises determining the battery discharge rate, and displaying an indication of the battery discharge rate as the energy consumption rate of the device. The battery discharge rate is determined one or both of directly and indirectly. The displayed indication is one or both of a relative form and an absolute form of the energy consumption rate.

### TECHNICAL FIELD

The invention relates to battery-powered electronic devices. In particular, the invention relates to monitoring and reporting an energy consumption rate for a battery powering the device.

### BACKGROUND OF THE INVENTION

Electronic devices are often equipped with a battery fuel gauge. The battery fuel gauge provides a user of the device an indication of a remaining charge or energy level stored in a battery. Battery fuel gauges are typically based on either current monitoring or voltage-slope monitoring to generate a fuel gauge result. In current monitoring, a current flowing from the battery is monitored and an accumulated or integrated total current over time is employed to determine a charge removed or drained from the battery. Given an initial charge stored in the battery, a charge remaining may be computed as a difference between the initial charge and the accumulated total charge removed. Voltage slope monitoring employs a change in a battery voltage over time to infer the remaining charge. Typically, voltage slope monitoring uses a look-up table, a curve, or a mathematical model that relates the battery voltage to the remaining charge. Either current monitoring or voltage monitoring can produce a reasonably accurate indication of remaining charge in typical electronic device applications.

Unfortunately, conventional battery fuel gauges provide little information or feedback to the user regarding how the device is best used to optimize or maximize an operational time of the device with a given battery. The remaining charge is often a poor indication of how long the device can operate without requiring a freshly charged battery. Moreover, many devices have multiple modes, some of which can perform essentially identical functions, but often have very different power utilization characteristics. Thus, how long a device can operate with a given remaining charge level depends heavily on how the device is used. Conventional fuel gauges do not provide any information to the user regarding how the usage of the device affects battery discharge and operational time of the device.

Accordingly, it would be advantageous to have a way of providing an indication or feedback to the user of the device that may facilitate maximizing the operational time of the device with a given battery. Moreover, such a form of feedback may also assist the user in learning to use the device more efficiently. Such an indication or feedback would solve a long-standing deficiency in the area of fuel gauging for battery powered electronic devices.

### SUMMARY OF THE INVENTION

The present invention indicates a rate of energy consumption by a battery-powered electronic device. In particular, the present invention determines and displays to a user of the battery-powered device an energy consumption rate or energy discharge rate of a battery that provides power to the device. The energy consumption rate may be displayed in the form of a consumption-rate meter or gauge on the device. Using the displayed energy consumption rate, the user may be able to estimate a probable operational time remaining for the device given an existing charge level of the battery. Moreover, the consumption rate indication may assist the user in modifying a usage of the device, such that an overall operational time of the battery-powered device is maximized. The present invention is applicable to any battery-powered electronic device that monitors battery charge level, including but not limited to, digital cameras, laptop computers, personal digital assistants, cellular telephones, and compact disk players.

In an aspect of the invention, an energy consumption-rate meter or gauge for use with a battery-powered electronic device is provided. The energy consumption meter comprises a battery monitor and a display unit. The battery monitor determines an energy consumption rate of the electronic device for a battery installed in the device. The display unit displays an indication of the determined energy consumption rate. In other aspects of the invention, a battery-powered electronic device having an energy consumption-rate meter and a method of gauging an energy consumption rate for a battery-powered electronic device are provided.

The present invention advantageously provides a user of a battery-powered electronic device feedback regarding a way the device is being used. Among other things, the present invention may facilitate an energy-efficient use model for the device. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a block diagram of an energy consumption-rate gauge used with a battery-powered electronic device according to the present invention.

FIG. 2 illustrates a schematic diagram of a current sensor portion used in the battery monitor of the present invention according to a preferred embodiment.

FIG. 3A illustrates an exemplary diagram of an embodiment of a display unit of the energy consumption-rate gauge illustrated in FIG. 1.

FIG. 3B illustrates an exemplary diagram of another embodiment of the display unit of the energy consumption-rate gauge illustrated in FIG. 1.

FIG. 3C illustrates an exemplary diagram of yet another embodiment of the display unit of the energy consumption-rate gauge illustrated in FIG. 1.

FIG. 4 illustrates a block diagram of an electronic device having an energy consumption-rate meter according to the present invention.

FIG. 5 illustrates is a perspective view of an exemplary digital camera embodiment of the electronic device of FIG. 4.

FIG. 6 illustrates a flow chart of a method of gauging an energy consumption rate according to the present invention.

FIG. 7A illustrates a flow chart of an embodiment of determining an energy consumption rate of the method of FIG. 6.

FIG. 7B illustrates a flow chart of another embodiment of determining an energy consumption rate of the method of FIG. 6.

### MODES FOR CARRYING OUT THE INVENTION

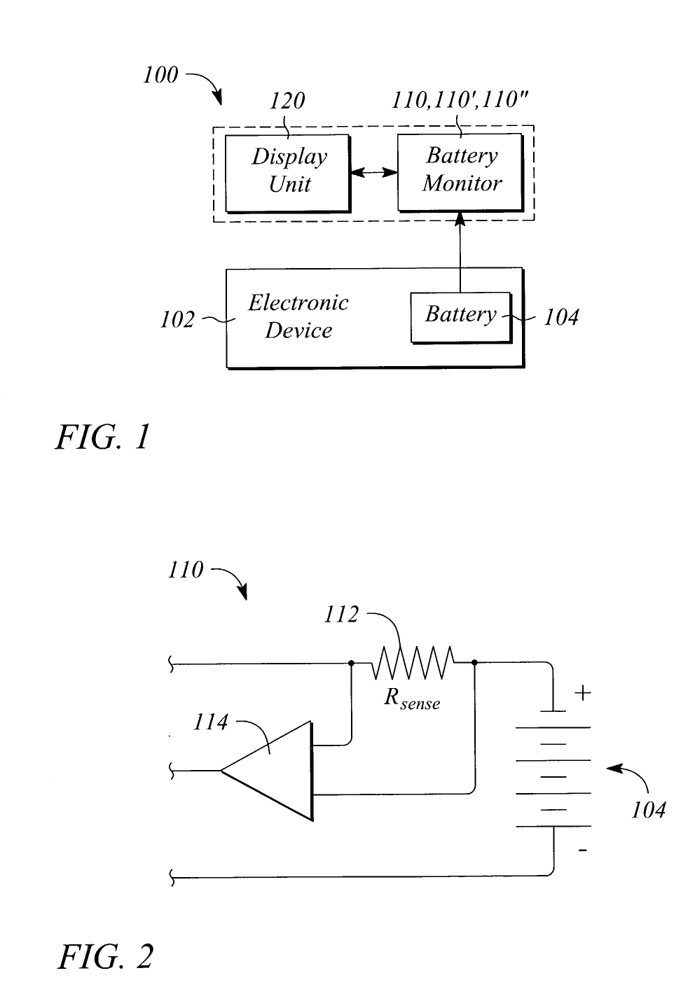

FIG. 1 illustrates a block diagram of an energy consumption-rate meter or gauge 100 according to the present invention for use with a battery-powered electronic device 102. The energy consumption-rate meter 100 displays an indication of a rate that the electronic device 102 consumes energy. For the battery-powered device 102, a battery 104 supplies the energy that is being consumed, thus the energy consumption rate is equivalent to an energy discharge rate of the battery 104, according to the present invention. The discharge rate is a rate of decrease of a charge of the battery as a function of time. The energy consumption-rate meter 100 of the present invention displays the consumption rate to a user of the electronic device 102.

The energy consumption-rate gauge 100 also may take into account a behavior of the battery with respect to a chemistry of the battery and/or a state of charge of the battery. For example, some battery chemistries output considerably less overall energy under high loads than under low loads. Thus, the energy consumption-rate indication provided by the energy consumption-rate meter 100 may be adjusted based on an identified battery chemistry. Such an adjusted indication that accounts for battery chemistry may be used to provide more information to the user than simply the present energy consumption rate of the device 102. For example, Bean et al. disclose several approaches to battery chemistry identification that may be employed in conjunction with the present invention in a patent application entitled “A Method Of Battery Chemistry Identification Through Analysis Of Voltage Behavior”, Ser. No. 09/859,015, filed May 14, 2001, incorporated by reference in its entirety herein.

The energy consumption-rate meter 100 comprises means for determining the energy consumption rate of the electronic device, and means for displaying an indication of the determined energy consumption rate. In some embodiments, the means for determining comprises a battery monitor 110, and the means for displaying comprises a display unit 120. The battery monitor 110 measures a characteristic of the battery 104 to determine the energy consumption rate and communicates the energy consumption rate to the display unit 120. The battery characteristic measured may include, but is not limited to, an electric current flowing from the battery 104 and/or a change in a voltage of the battery 104 as a function of time. The display unit 120 displays the determined energy consumption rate to the user.

In a preferred embodiment, the battery monitor 110 measures an electric current flowing from the battery 104. Current flowing from the battery 104 may be used to determine a consumption-rate value that is proportional to the energy consumption rate for the battery-powered device 102. Preferably, the current measurement is combined with a priori information regarding a behavior of the energy capacity of the battery at various current levels to determine the consumption-rate value. Advantageously, current flowing from the battery 104 is readily measurable in most electronic devices using a current sensor or probe. Many current sensing or measuring methodologies and associated means for sensing are well known in the art for measuring current. All such methodologies and sensing means are within the scope of the present invention.

For example, FIG. 2 illustrates a schematic diagram of a preferred current sensor portion used in the battery monitor 110. The preferred current sensor portion comprises a so-called ‘sense’ resistor 112 that is placed in series with the battery 104. Typically, the sense resistor 112 is a stable precision resistor having a very small resistance value. Current flowing through the sense resistor 112 produces a voltage across the sense resistor 112 that is proportional to the current according to Ohm's law. Thus, by measuring the voltage across the sense resistor 112, the current can be determined.

The current sensor portion illustrated in FIG. 2 employs the sense resistor 112 in series with a positive terminal (+) of the battery 104. Such a configuration is often referred to as having the sense resistor on a ‘high-side’ of a power supply circuit since by convention, a negative terminal of the battery 104 is connected to a ground potential. An alternative configuration that is within the scope of the invention (not illustrated) uses a ‘low-side’ sense resistor 112 that is in series with the negative terminal of the battery 104. FIG. 2 also illustrates, in accordance with a preferred embodiment, a buffer amplifier 114 that senses and amplifies the voltage across the sense resistor 112 while simultaneously isolating the sense resistor from any load that may be placed on an output of the amplifier 114.

While a basic current sensor may be realized using a sense resistor 112 and preferably, a simple buffer amplifier 114 circuit that may be constructed using an operational amplifier (Opamp), a wide variety of specialized integrated circuits (ICs) are also available from a number of different manufacturers that can be used as the battery monitor 110 of the present invention. For example, a Precision, High-side Current-Sense Amplifier, model number MAX471, manufactured by Maxim Integrated Products, Inc., Sunnyvale, Calif. is one such IC that may be used as the current sensor portion of the battery monitor 110. The MAX471 Amplifier provides an integrated 35 mω sense resistor and outputs a buffered voltage, the magnitude of which is proportional to the current flowing in the sense resistor.

Another example of a specialized current sensor IC that may be used as the current sensor portion of the battery monitor 110 is the Precision Current Gauge IC, model number LM3812/3, manufactured by National Semiconductor Corporation, Santa Clara, Calif. The LM3812/3 Gauge IC outputs a pulse width modulated (PWM) signal, the pulse width of which is proportional to the sensed current. Many other current sensing products are available, all of which are useful for the battery monitor 110 and are within the scope of the present invention.

In some implementations of the current sensor portion, the battery monitor 110 further comprises an analog to digital converter (ADC) (not illustrated). The ADC converts an output of the current sense portion of the battery monitor 110 into a digital representation of the sensed current. The ADC may even take the place of the buffer amplifier and convert the voltage across the sense resistor 112 directly into a digital representation. Whether or not the ADC is used often depends on an input data format expected by or compatible with the display unit 120.

In other embodiments, the battery monitor 110′ measures a change in a battery voltage as a function of time. In general, if a change in the battery voltage as a function of time is measured, the measurements are converted into a discharge rate or energy consumption rate using an a priori known relationship between the battery voltage and a remaining charge stored in the battery 104. Such a relationship may take the form of a look-up table, a curve, or a mathematical function. One of ordinary skill in the art is familiar with the use of a relationship between battery voltage and battery charge level to determine remaining charge stored in a battery. A change in remaining charge with respect to time is used to determine the discharge rate or energy consumption rate for the battery-powered electronic device 102.

A voltage measurement portion of the battery monitor 110′ may be realized or implemented in a variety of ways by one of ordinary skill in the art. For example, the voltage measurement portion of the battery monitor 110′ may comprise an ADC, a microprocessor or microcontroller, a memory, and a computer program stored in the memory. The microprocessor executes the computer program, wherein instructions of the program implement the functions of the battery monitor through control of the ADC and by using the relationship between a battery voltage and a remaining charge level that is stored in the memory. In particular, the ADC periodically measures or samples and converts the battery voltage to a digital representation. The microprocessor receives the digital representation of the measured battery voltage and compares the measured voltage to a previously measured voltage to compute a change in voltage. The microprocessor then uses the relationship between battery voltage and remaining charge to compute a discharge or energy consumption rate. While described with respect to a microprocessor implementation, one skilled in the art can readily devise analog circuits or a combination of analog and digital circuits that can perform the voltage measurement and comparison as well as the energy consumption rate computation described hereinabove. All such means for measuring and means for computing are within the scope of the present invention.

In yet other embodiments, the battery monitor 110″ provides for both current sensing and battery voltage measuring to determine the energy consumption rate. Alternatively, the battery monitor 110″ provides for monitoring other characteristics or combinations of characteristics of the battery 104 to determine the energy consumption rate. All of such embodiments are within the scope of the present invention.

The battery monitor 110, 110′, 110″ may communicate the determined energy consumption rate to the display unit 120 in any of a variety of ways. In some embodiments, the battery monitor 110, 110′, 110″ may simply produce a signal, a voltage, a current, a pulse width, or a frequency that is proportional to the determined energy consumption rate. For example, as described hereinabove, the signal may be the voltage measured across the sense resistor 112, the voltage being proportional to the current flowing in the resistor.

The battery monitor 110, 110′, 110″ may convert and/or scale the determined energy consumption rate before communicating the rate to the display unit 120. For example, the determined energy consumption rate may be logarithmically scaled to accentuate a difference between a low energy consumption rate and a high energy consumption rate. Alternatively and/or additionally, the energy consumption rate may be transformed from an analog signal into a digital format. A digital format is a digital signal that represents the determined energy consumption rate as a digital representation.

Whether the current sensor or voltage measurement portions are used, as mentioned hereinabove, the battery monitor 110 further comprises an analog to digital converter (ADC) that measures, converts and encodes the voltage as a digital representation. In general, the digital representation may be either a serial representation or parallel representation of the determined energy consumption rate. A serial representation comprises a time sequence of bits communicated one bit at a time, wherein sets of the bits represent one or more digital words that encode the energy consumption rate. The parallel representation comprises a plurality of simultaneously communicated bits. Once again, one or more digital words may be used to encode the energy consumption rate. One skilled in the art is familiar with serial and parallel digital communication of encoded information.

For example, the battery monitor 110 may convert the energy consumption rate into an RS-232 serial format comprising a plurality of digital words that represent the determined energy consumption rate. In this example, the battery monitor 110 may further comprise a universal asynchronous receiver transmitter (UART) for producing the RS-232 serial format from the digital representation output by the ADC. One of ordinary skill can readily devise a wide array of conversions and scalings that may be performed by the battery monitor 110, 110′, 110″ and circuits that implement these conversions and scalings. All such conversions and scalings and circuits are within the scope of the present invention.

The display unit 120 receives the communicated consumption rate or consumption-rate value, formats the consumption rate as a consumption-rate indication, and displays the indication to the user. The display unit 120 may present the consumption-rate indication in any one of a variety of formats including, not limited to, a bar graph, a numerical readout, a pie chart, a line graph, or a multi-stage iconic representation.

In a preferred embodiment, the energy consumption-rate indication is displayed as a relative, normalized energy consumption rate as opposed to an absolute energy consumption rate. In particular, the energy consumption-rate indication is displayed as a low rate indication for a low energy consumption rate and a high rate indication for a high consumption rate. The preferred indication is said to be ‘relative’ since no attempt is made to make the indication correspond to an actual or absolute measure of energy consumption rate, such as Watts. However, an indication corresponding to the absolute measure of energy consumption rate is within the scope of the present invention.

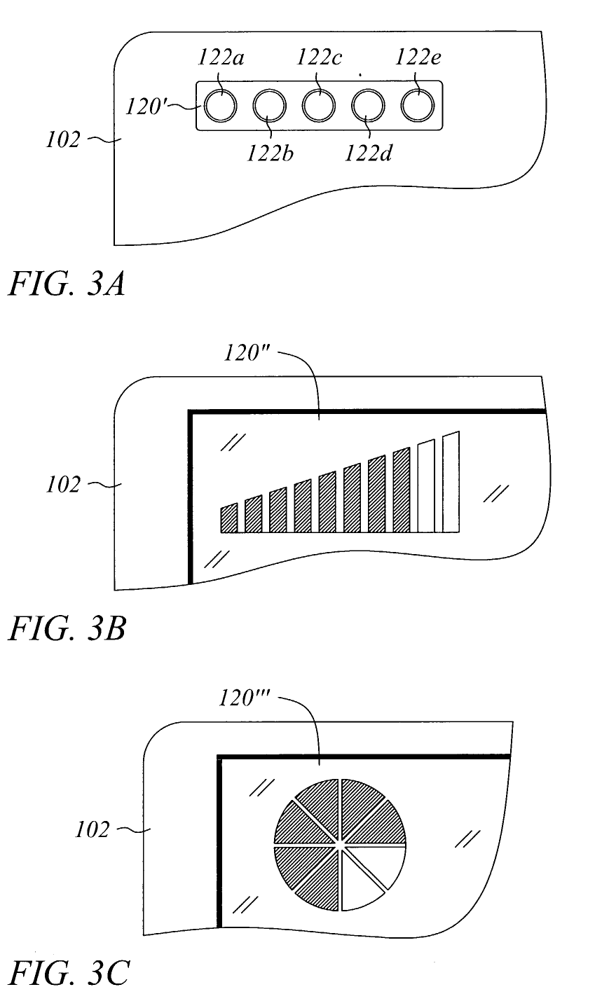

For example, consider an exemplary embodiment 120′ of the display unit 120 comprising a set of five light emitting diodes (LEDs) arranged in a row, as illustrated in FIG. 3A. A low energy consumption rate is indicated with such a display unit 120′ by illuminating only a first LED 122a. A high energy consumption rate is indicated when all five LEDs 122a, 122b, 122c, 122d, and 122e are illuminated. Similarly, an intermediate energy consumption rate may be indicated when the first three LEDs 122a, 122b, 122c, for example, are illuminated, and so on. FIG. 3B illustrates another example embodiment 120″ of a display unit 120 comprising a portion of a liquid crystal display (LCD) of the electronic device 102 having a stylized bar graph icon for indicating relative energy consumption rate. A degree to which the bar graph is illuminated is used to indicate the relative energy consumption rate in a way similar to that described above for the LED display unit 120′.

FIG. 3C illustrates yet another form of an LCD display-based iconic display unit 120′″ embodiment in which the relative energy consumption rate is depicted using a pie chart icon. Illuminating various portions of the pie chart icon indicates different levels of relative energy consumption rate. A highest energy consumption rate is indicated by a ‘full’ pie chart icon, where all or at least a majority of the pie portions are illuminated, while an ‘empty’ pie chart icon indicates a lowest energy consumption rate when none or at most a minority of the pie pieces are illuminated.

In yet another example (not illustrated), the energy consumption-rate indication may comprise a displayed number ranging from zero to ten, for example, that is displayed on a portion of the LCD display unit 120. With this sort of approach, a lowest energy consumption rate is normalized to zero while a highest energy consumption rate is normalized to ten, for example. Even a conventional meter employing a mechanical needle that is deflected an amount proportional to the energy consumption rate may be employed as the display unit 120. One skilled in the art is familiar with these as well as other means for displaying, all of which are within the scope of the present invention.

As opposed to conventional fuel gauging that provides an indication of a charge remaining in the battery, advantageously the present invention provides an indication of the energy consumption rate to the user of the device 102. Such information may be employed by the user to modify the way the user employs the device 102, among other things. In particular, the user can use the energy consumption-rate indication provided by the present invention to choose an operational mode having a lowest energy consumption rate from several operational modes for performing a particular function. By choosing a lowest energy consumption-rate mode, an overall operational lifetime of the battery 104 may be increased or preferably, maximized.

Conventional fuel gauging in electronic devices, even fuel gauging that employs current monitoring, does not provide an indication of the energy consumption rate to the user of the device. Thus, without the energy consumption-rate indication according to the present invention, the user has no feedback regarding how to maximize battery lifetime with conventional fuel gauging. Moreover, the present invention may be used in conjunction with conventional fuel gauging to provide a dual indication of energy consumption rate and remaining battery charge. In some embodiments, the battery monitor 110 may serve a dual role both in support of conventional fuel gauging and for an energy consumption-rate determination according to the present invention.

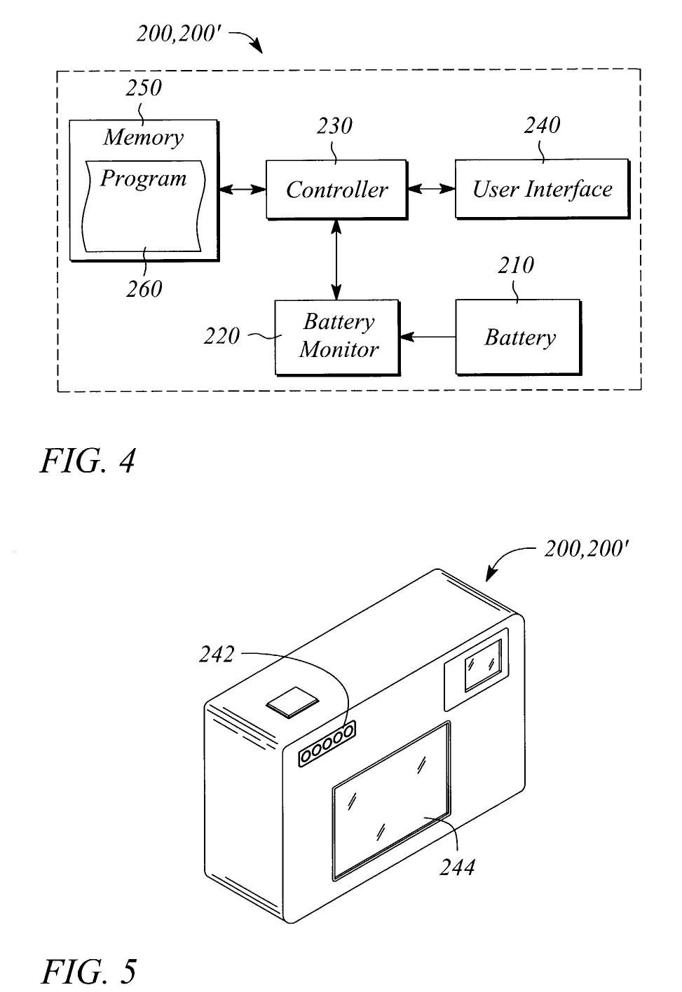

In another aspect of the invention, a battery-powered electronic device 200 having an energy consumption-rate meter is provided. FIG. 4 illustrates a block diagram of an electronic device 200 having an energy consumption-rate meter according to the present invention. The energy consumption-rate meter indicates a rate of energy consumption by the device 200. The electronic device 200 operates using a battery 210 for power/energy and comprises a processor or controller 230, a user interface 240 having a display, a memory 250, and a computer program 260 stored in the memory 250. The processor 230 executes instructions of the computer program 260 to determine a rate of energy discharge of the battery 210, when the battery 210 is installed in the device 200, and computes an energy consumption rate of the device 200. The processor 230 communicates the computed energy consumption rate to the user interface 240. The user interface 240 displays the energy consumption rate on the display for a user of the device 200.

In some embodiments, the processor 230 uses a priori information regarding power or energy utilization by an operational mode of the device 200 to indirectly determine the battery discharge rate from the mode that is active or is used in the device 200. In particular, the energy consumption rate may be known a priori because the energy consumption rate was determined for each of a plurality of operational modes at some time prior to the use of the device 200. For example, the device 200 may have six operational modes and a respective power or energy utilization level for each mode may be measured or computed during manufacture. The measured or computed power/energy utilization levels are then stored in a look-up table indexed by mode in the memory 250. The processor 230 determines the energy consumption rate by simply noting which of the six exemplary modes is currently active and computing a corresponding consumption rate either directly from the data in the look-up table for the active mode or from the look-up table data combined with other data or a priori information. For example, the data from the look-up table may be combined with data or a priori information also stored in memory regarding an energy output versus a power output behavior of a particular battery chemistry being used to power the electronic device 200.

In other embodiments, the battery-powered device 200′ further comprises a battery monitor 220 that directly measures a characteristic of the battery 210. For example the battery monitor 220 may measure an electric current flowing from the battery 210 or a change in a battery voltage as a function of time. The battery monitor 220 communicates the measured characteristic to the processor 230, and the processor 230 directly determines the battery discharge rate from the communicated measurements.

FIG. 5 illustrates an exemplary digital camera embodiment of the electronic device 200, 200′ illustrated in FIG. 4 having an energy consumption-rate meter. While illustrated as a digital camera, the electronic device 200, 200′ may be any battery-powered device that monitors battery usage. Examples of embodiments of the electronic device 200, 200′ other than the digital camera illustrated in FIG. 5 include, but are not limited to, a laptop computer, cellular or portable telephone, a personal digital assistant (PDA), a video camera, and a compact disk or MP3 player. One skilled in the art may readily devise a variety of other device embodiments to which the invention is applicable. All such device embodiments are within the scope of the present invention.

The exemplary digital camera device 200, 200′ has an energy consumption-rate meter portion of the user interface 240 comprising a set of five LEDs 242, for example. The exemplary five LEDs 242 indicate power consumed by the digital camera 200, 200′, as described with respect to the display unit 120′ illustrated in FIG. 3A. In particular, a lowest energy consumption rate is indicated when none of the LEDs of the set of five LEDs 242 are illuminated, for example. A highest energy consumption rate is indicated when all five LEDs of the set of LEDs 242 are illuminated, for example. Intermediate energy consumption rates between the lowest and the highest rates are indicated when more than none but less than five LEDs of the set of LEDs 242 are illuminated. Thus, the energy consumption-rate meter portion of the user interface 240 essentially uses the set of five LEDs 242 as a bar graph to indicate a relative energy consumption rate of the exemplary camera 200, 200′.

The user interface 240 of the exemplary camera 200, 200′ further comprises an image display 244. The image display 244 may be a liquid crystal display (LCD). In other embodiments, the exemplary camera 200, 200′ may provide an energy consumption-rate meter comprising an iconic display located in the image display 244, for example. Two such iconic displays indicating the energy consumption rate that may be displayed on the image display 244 of the exemplary camera 200, 200′ were described hereinabove with respect to the display units 120″, 120′″ illustrated in FIGS. 3B and 3C, respectively. Such an iconic display-based energy consumption-rate meter may be provided instead of or in addition to the LED-based energy consumption-rate meter using the set of five LEDs 242, for example. Furthermore, the iconic display-based energy consumption-rate meter 120″, 120′″ may be implemented on another LCD display (not illustrated) instead of the image display 244.

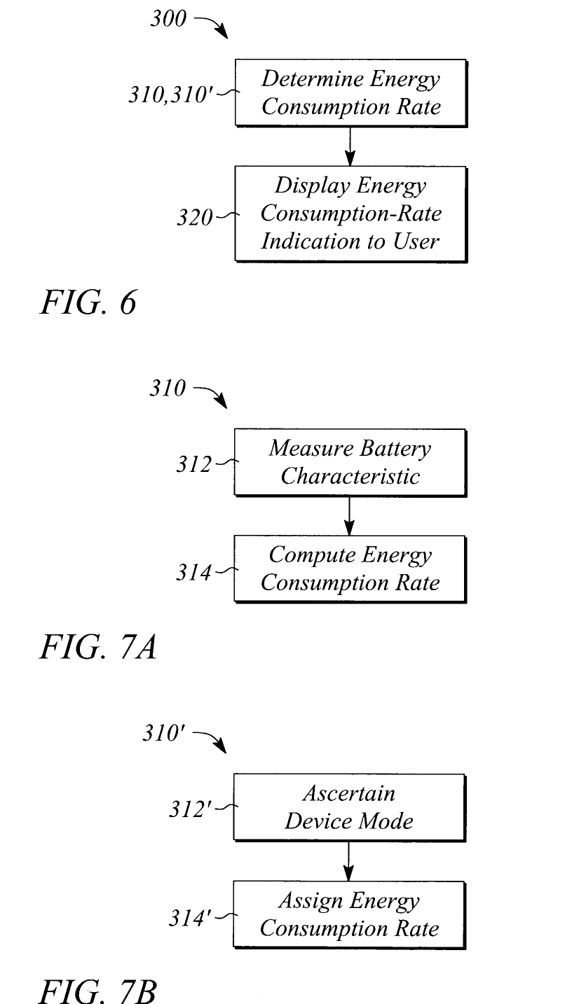

In yet another aspect of the invention, a method 300 of gauging an energy consumption rate for a battery-powered electronic device is provided. FIG. 6 illustrates a flow chart of the method 300 of energy consumption-rate gauging according to the present invention. The method 300 of gauging provides an indication of the energy consumption rate to a user of the battery-powered electronic device. The energy consumption rate is equivalent to an energy discharge rate of a battery that powers the electronic device.

The method 300 comprises determining 310 the energy consumption rate of the battery-powered device. In some embodiments, the energy consumption rate is determined 310 directly from measurements of a characteristic of the battery. For example, measurements of an electric current flowing from the battery or a change in a battery voltage as a function of time may be used to determine 310 the energy consumption rate. FIG. 7A illustrates the method of directly determining 310 the energy consumption rate. Determining 310 directly comprises measuring 312 a characteristic of the battery, and computing 314 the energy consumption rate from the measured characteristic.

For example, computing 314 may normalize a measured current proportional to the energy consumption rate to a scale defined by a maximum current flow and a minimum current flow. In particular, a value of the current flowing from the battery is measured 312. Computing 314 then comprises dividing a difference between the measured current value and a minimum current value by a difference between a maximum current value and the minimum current value.

In other embodiments, the energy consumption rate is determined 310′ indirectly from a priori information regarding power consumption of an operational mode of the device combined with a length of time that the mode is active in the device. FIG. 7B illustrates the method of indirectly determining 310′ the energy consumption rate. Determining 310′ indirectly may comprise ascertaining 312′ a mode of the device and assigning 314′ an energy consumption rate for the ascertained 312′ mode. Preferably, assigning 314′ employs a look-up table having entries that relate each mode of the device to a respective energy consumption rate.

Determining 310, 310′ the energy consumption rate may further comprise adjusting the energy consumption rate according to one or both of a battery chemistry and a state of charge of the installed battery. The battery chemistry of the installed battery may be determined in situ or may be known a priori. The state of charge may be determined using any one of a number of fuel gauging methodologies including those known in the art. The adjustment of the energy consumption rate using one or both of a battery chemistry and a state of charge of the battery is applicable whether determined 310 directly from the measured characteristic or determined 310′ indirectly from a priori information associated with the operational mode. Since the adjustment for chemistry and charge state also depends on the particular type of electronic device being used (i.e., whether a digital camera, cellular telephone, etc.), the present invention is not limited to any particular way to adjust the energy consumption rate herein. However, one of ordinary skill in the art can readily determine the appropriate adjustment for a particular device without undue experimentation.

For example, since it is known that battery chemistry affects energy available from a given battery under various loads, information regarding battery chemistry of the installed battery may be employed to adjust, and thereby improve, the accuracy and applicability of the determined 310, 310′ energy consumption rate. Likewise, since it is known that for some battery types, the remaining charge or charge state of the battery may affect an amount of energy delivered or available under various loads, the remaining charge may be used to adjust the energy consumption rate to produce a more accurate result. Ultimately, the adjustment is intended to combine power level or energy consumption rate data with battery chemistry and/or state of charge data to produce a more accurate or realistic measure of a ‘true’ energy consumption rate for a given installed battery.

The method 300 further comprises displaying 320 an indication of the determined 310, 310′ energy consumption rate to a user of the device. In a preferred embodiment, the energy consumption rate is displayed 320 using a relative scale. The determined energy consumption rate may be displayed 320 on a display unit of the device. Any conventional display methodology may be employed to display 320 the determined 310, 310′ energy consumption rate including, but not limited to, a curve, bar graph, pie chart, iconic display, or numeric display. For example, a relative energy consumption rate may be display as a number that ranges from zero to ten, where zero indicates a lowest energy consumption rate and ten indicates a highest energy consumption rate. In another example, the energy consumption rate may be displayed 320 using a linear array of LEDs forming a bar graph wherein a lowest energy consumption rate is indicated by illuminated one LED and a highest energy consumption rate is indicated by illuminating all of the LEDs. These examples are described above. One skilled in the art is familiar with and can devise many such display methodologies suitable for displaying 320 the energy consumption rate. All such display methodologies are within the scope of the present invention.

Moreover, it is within the scope of the present invention for the electronic device 200, 200′ to have an intelligence, such that the intelligent electronic device advises the user to use only the operational modes that consume the least amount of power, when there is more than one mode that can be chosen for a particular function. In such an intelligent electronic device 200, 200′, instructions to the user on how to use the device 200, 200′ more energy-efficiently are displayed, rather than, or in addition to, displaying a relative energy consumption rate. Alternatively, the device 200, 200′ automatically operates in the modes that the device determines are most energy efficient. In this alternative embodiment, the intelligent device 200, 200′ need not display instructions or energy consumption rate information to the user. In still another embodiment of the intelligent electronic device 200, 200′ of the present invention, a combination of some instructions to the user and automatic mode operation is employed. The intelligence may be implemented by way of a microprocessor executing a computer program, for example.

Thus, there have been described an energy consumption-rate meter 100 for an electronic device, an electronic device 200, 200′ having a energy consumption-rate meter and a method 300 of gauging a energy consumption-rate for an electronic device. It should be understood that the above-described embodiments are merely illustrative of the some of the many specific embodiments that represent the principles of the present invention. Clearly, those skilled in the art can readily devise numerous other arrangements without departing from the scope of the present invention as defined by the following claims.

What is claimed is:

1. An energy consumption rate meter for a battery-powered electronic device comprising:
a battery monitor that determines an energy consumption rate of the electronic device for a battery installed in the device; and
a display unit that displays an indication of the determined energy consumption rate.

2. The energy consumption rate meter of claim 1, wherein the battery monitor comprises a sensor portion, the sensor portion comprising a current sensor that measures an electric current flowing from the battery to determine the energy consumption rate.

3. The energy consumption rate meter of claim 1, wherein the battery monitor comprises a sensor portion, the sensor portion comprising a voltage sensor that measures a change in a voltage of the battery as a function of time to determine the energy consumption rate.

4. The energy consumption rate meter of claim 3, wherein the voltage sensor comprises:
an analog to digital converter that periodically measures a voltage of the battery and converts the measured battery voltage to a digital representation;
a microprocessor that receives the digital representation;
a memory; and
a computer program stored in the memory, the computer program being executed by the microprocessor,
wherein instructions of the computer program compare the received digital representation of the measured voltage to a previously measured voltage to compute a change in battery voltage, the change in voltage being indicative of energy consumed between times that the analog to digital converter periodically measures the voltage.

5. The energy consumption rate meter of claim 3, wherein the voltage sensor further uses a relationship between battery voltage and a remaining charge stored in the battery to determine the energy consumption rate, the relationship being known a priori.

6. The energy consumption rate meter of claim 5, wherein the a priori-known relationship has one or more forms selected from a look-up table, a curve, and a mathematical function.

7. The energy consumption rate meter of claim 1, wherein the sensor portion comprises one or both of:
a voltage sensor that measures a change in a voltage of the battery as a function of time to determine the energy consumption rate; and
a current sensor that measures an electric current flowing from the battery to determine the energy consumption rate.

8. The energy consumption rate meter of claim 1, wherein the battery monitor further converts the determined energy consumption rate into a normalized form before communicating the rate to the display unit.

9. The energy consumption rate meter of claim 1, wherein the battery monitor logarithmically scales the determined energy consumption rate to accentuate a difference between a low energy consumption rate and a high energy consumption rate.

10. The energy consumption rate meter of claim 1, wherein the indication of the determined energy consumption rate displayed is one or both of a relative form and an absolute form.

11. The energy consumption rate meter of claim 1, wherein the display unit comprises one or more of a plurality of light emitting diodes, an LCD ionic display, a numerical display, and a deflectable mechanical needle.

12. The energy consumption rate meter of claim 1, wherein the display unit further displays an operational mode associated with the determined energy consumption rate.

13. A battery-powered electronic device that operates using one or more operational modes and that has an energy consumption-rate meter comprising:
a processor;
a user interface having a display;
a memory; and
a computer program stored in the memory and executed by the processor, the computer program having instructions that implement determining a rate of energy discharge from a battery that is installed in the device, wherein an indication of the determined battery discharge rate is displayed on the display of the user interface.

14. The battery-powered electronic device of claim 13, wherein a battery discharge rate for each operational mode of the device is stored in the memory, and wherein the instructions that determine the battery discharge rate comprise accessing the battery discharge rate from the memory for a corresponding operational mode.

15. The battery-powered electronic device of claim 14, wherein the battery discharge rate for each operational mode of the device is determined a priori and is stored in a look-up table indexed by mode in the memory in association with device manufacture.

16. The battery-powered electronic device of claim 13, wherein the instructions that determine the battery discharge rate further adjust the discharge rate for one or both of a battery chemistry and a remaining battery charge of the installed battery.

17. The battery-powered electronic device of claim 13, further comprising a battery monitor, wherein the instructions that determine the battery discharge rate comprise measuring a characteristic of the installed battery with the battery monitor, and computing the battery discharge rate from the measured characteristic with the processor.

18. The battery-powered electronic device of claim 13 in the form of a portable device selected from a digital camera, a laptop computer, cellular telephone, a personal digital assistant (PDA), a video camera, and a compact disk player.

19. The battery-powered electronic device of claim 13 in the form of a digital camera.

20. A method of gauging an energy consumption rate for a battery-powered electronic device comprising:
determining a rate of energy discharge from a battery installed in the electronic device, the battery discharge rate being equivalent to the energy consumption rate; and
displaying an indication of the energy consumption rate for a user of the device.

21. The method of claim 20, wherein determining a rate of energy discharge comprises:
measuring a characteristic of the installed battery; and
computing the battery discharge rate from the measured characteristic.

22. The method of claim 21, wherein computing the battery discharge rate comprises adjusting the battery discharge rate according to a chemistry of the installed battery.

23. The method of claim 21, wherein computing the battery discharge rate comprises adjusting the battery discharge rate according to a remaining charge on the installed battery.

24. The method of claim 20, wherein determining a rate of energy discharge comprises:
ascertaining an operational mode being used in the device; and
assigning a battery discharge rate to the ascertained mode.

25. The method of claim 24, wherein assigning a battery discharge rate comprises employing a look-up table having entries that relate each mode of the device to a respective battery discharge rate.

26. The method of claim 25, wherein employing a look-up table comprises determining a respective battery discharge rate for each mode using a priori information about the device.

27. The method of claim 25, wherein the employed look-up table accounts for each battery chemistry used by the device.

28. The method of claim 20, wherein the battery discharge rate is determined one or both of directly using measurements of the installed battery and indirectly using a priori energy consumption information about the device operational modes.

29. The method of claim 20, wherein displaying an indication of the energy consumption rate for a user comprises using one or both of actual values and a relative scale for the indication.

30. The method of claim 20, wherein determining a rate of energy discharge accounts for one or both of a battery chemistry of the installed battery and a remaining charge on the installed battery.

31. A method of gauging an energy consumption rate for a battery-powered electronic device comprising:
determining a rate of energy discharge from a battery installed in the electronic device, the device having one or more operational modes, the battery discharge rate being equivalent to the energy consumption rate; and
using the determined battery discharge rate to operate the device energy-efficiently.

32. The method of claim 31, wherein using the determined battery discharge rate comprises displaying an indication of the determined battery discharge rate to a user of the device.

33. The method of claim 31, wherein determining a rate of energy discharge comprises determining a respective rate for each operational mode used with the installed battery.

34. The method of claim 33, wherein an operation of the device has more than one operational mode, and wherein using the determined battery discharge rate comprises operating the device in those operational modes having a relatively low energy consumption.

35. An energy consumption-rate meter for a battery-powered electronic device comprising:
means for determining an energy consumption rate of the electronic device for a battery installed in the device; and
means for displaying an indication of the determined energy consumption rate.

36. The energy consumption rate meter of claim 35, wherein the means for determining an energy consumption rate comprises means for measuring a characteristic of the installed battery, and means for computing the energy consumption rate from the measured characteristic, the battery characteristic being proportional to the energy consumption rate.

37. The energy consumption rate meter of claim 35, wherein the means for determining an energy consumption rate comprises means for ascertaining an operational mode being used in the device; and means for assigning the energy consumption rate to the ascertained mode.

38. A battery-powered electronic device that operates using one or more operational modes comprising:
means for gauging an energy consumption rate of the device for each operational mode used with an installed battery.

39. The battery-powered electronic device of claim 38, wherein the means for gauging an energy consumption rate comprises means for determining a rate of energy discharge from the installed battery for the operational mode used, the battery discharge rate being equivalent to the energy consumption rate.

40. The electronic device of claim 39, wherein the means for determining a rate of energy discharge comprises means for ascertaining an operational mode being used in the device; and means for assigning the battery discharge rate to the ascertained mode.

41. The electronic device of claim 39, wherein the means for determining a rate of energy discharge comprises means for measuring a characteristic of the installed battery, and means for computing the battery discharge rate from the measured characteristic.

42. The battery-powered electronic device of claim 38, further comprising means for displaying an indication of the determined battery discharge rate.

43. The battery-powered electronic device of claim 38, further comprising means for using the energy consumption rate to operate the device energy-efficiently.
